(19) United States
(12) Patent Application Publication
(10) Pub. No.: US 2007/0034162 A1
(43) Pub. Date: Feb. 15, 2007

(54) Collapsible birdhouse

(75) Inventors: Michael S. Kellogg, Oconomowoc, WI (US); Adam M. Kellogg, Oconomowoc, WI (US)

Correspondence Address: RYAN KROMHOLZ & MANION, S.C., POST OFFICE BOX 26618, MILWAUKEE, WI, 53226, US

(73) Assignee: SportPet Designs, Inc.

(21) Appl. No.: 11/201,033

(22) Filed: Aug. 10, 2005

(51) Int. Cl. A01K 31/08

(52) U.S. Cl. 119/431

(57) ABSTRACT

A collapsible birdhouse or feeder having a bottom panel, a back panel having a foldable frame member, a front panel having a foldable frame member, and a top panel. A strap or suction cups are used to secure the structure to a support or window. The front panel has an opening to allow the ingress and egress of birds.

### BACKGROUND OF THE INVENTION

The present invention relates to collapsible structures and, specifically, to collapsible structures having panels that are foldable and can be reduced in size when the structure is collapsed. More specifically, the present invention pertains to a collapsible birdhouse.

Collapsible structures are known in the art. However, these prior art structures generally have been focused on structures designed for use as tents, play structures, containers, and laundry hampers. Recent structures have been designed for use as portable carriers and kennels for dogs and cats.

Bird watching is a popular past time. Many people set up bird feeders and birdhouses to attract birds near a house or in a designated area so that viewing of the birds is more accessible. Currently available birdhouses tend to be made of heavy materials, such as wood or plastic, and bird feeders also tend to be made of heavy materials, such as wood, glass, and/or Plexiglas®. Likewise, once the birdhouses are assembled, it normally requires removal of screws, nails, bolts, or other connectors to disassemble the birdhouse for cleaning or storage in a more compact state. This can also make transport of the currently available structures difficult.

Current birdhouses do not typically allow visual access to the birds once they have established a home inside of a birdhouse. An observer or birdwatcher generally will not be able to watch what takes place inside of the birdhouse. Because birds generally prefer to build nests in private, birdhouses have not been made of clear or translucent materials. A birdhouse and/or bird feeder is desirable that can be easily constructed, arranged, cleaned, or stored and will be more accessible to viewing the birds than prior art designs.

### SUMMARY OF THE INVENTION

The present invention comprises a collapsible structure having a bottom panel, a back panel having a foldable frame member, a front panel having a foldable frame member, and a top panel. A connecting mechanism, such as a strap or suction cups are used to secure the collapsible structure to a tree or window. The front panel has an opening for ingress and egress of birds that will allow the structure to serve as a birdhouse or bird feeder.

### BRIEF DESCRIPTION OF THE DRAWINGS

FIG. 1 is a partially cut-away perspective view of a birdhouse in accordance with the present invention.

FIG. 2 is a perspective view of a birdhouse in accordance with the present invention having a removable top panel and counterweight.

FIG. 3 is an exploded perspective view of the birdhouse of FIG. 1.

FIG. 3A is a cross-sectional view taken along line 3A-3A of FIG. 3 illustrating a frame member being retained within a sleeve.

FIG. 4 is a partially cut-away perspective view of the birdhouse of FIG. 1.

FIG. 5 is a rear perspective view of a birdhouse in accordance with the present invention.

FIG. 6 is a partially cut-away rear perspective view of another embodiment of the birdhouse of FIG. 5.

FIG. 7 is a rear perspective view of the birdhouse of FIG. 6 attached to a window.

FIGS. 8-10 depict a birdhouse according to the present invention being collapsed.

### DESCRIPTION OF THE PREFERRED EMBODIMENT

Although the disclosure hereof is detailed and exact to enable those skilled in the art to practice the invention, the physical embodiments herein disclosed merely exemplify the invention that may be embodied in other specific structures. While the preferred embodiment has been described, the details may be changed without departing from the invention, which is defined by the claims.

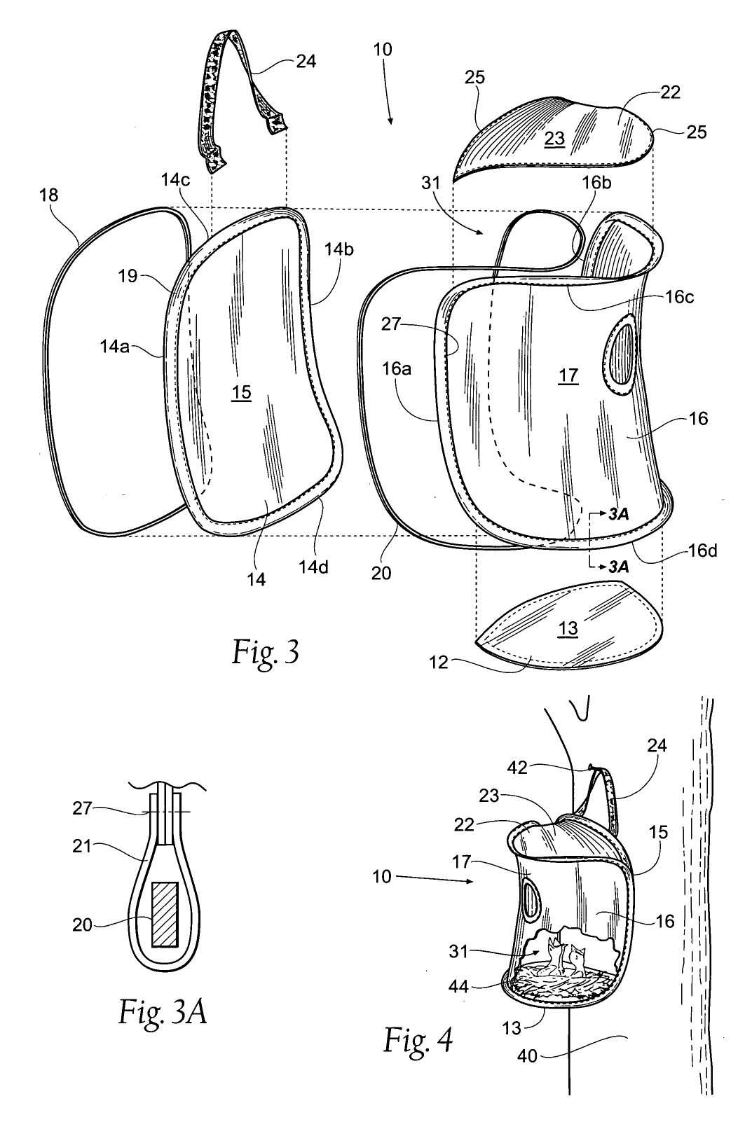

FIG. 1 depicts a collapsible birdhouse 10 in accordance with the present invention. The birdhouse 10 comprises four panels, a bottom panel 12, a back panel 14, a front panel 16 and a top panel 22. As shown in FIG. 3, bottom panel 12 and top panel 22 are formed from webs of material 13 and 23, respectively. Back panel 14 is formed from a web of material 15 connected about its periphery along its edges 14a, 14b, 14c, and 14d to a generally oval flexible frame 18 forming a panel having a collapsed configuration and an open configuration. Front panel 16 is also formed from a web of material 17 connected about its periphery along its edges 16a, 16b, 16c, and 16d to a “U” shaped flexible frame 20 again forming a panel having a collapsed configuration and an open configuration.

The front panel 16 and back panel 14 are coupled or connected to each other at the first edges 14a, 16a and also at the second edges 14b, 16b. Top panel 22 is connected along its periphery 25 to panels 14 and 16 while bottom panel 22 is connected in a similar manner to the panels 14 and 16 to define an interior space 31, which provides an area for a bird or birds to build a nest or feed. While stitching 27 forms the preferable connection, it is to be understood that other connection means such as gluing, welding, utilizing hook and loop fasteners and the like could be utilized.

Referring again to FIGS. 1 and 3, an attachment mechanism, such as strap 24 may be attached to the top panel 22 for supporting the birdhouse 10 on a pole, tree, or other structure that will support and elevate the birdhouse 10 above the ground. The preferred attachment mechanism 24 is shown as a loop of material that can easily be hooked over a tree branch or other structure (see FIG. 4). As will be apparent with the following discussion and drawings, the attachment mechanism 24 can cover a wide range of structures and still fall within the present invention.

FIG. 3A provides a cross-sectional view of the frame member 20 sitting within a frame retaining sleeve 21. The frame member 20 is maintained within the sleeve 21 to support the panel 16. The frame member 18 (see FIG. 3) is retained within a sleeve 19 in the same fashion as the frame member 20 is retained within the retaining sleeve 21.

The continuous frame members 18 and 20 of each panel 16, 14 may be provided as one continuous loop, or may be a strip of material connected at both ends to form a continuous loop. The frame members 18 and 20 are preferably formed of flexible coilable steel, although other materials such as plastics may also be used. The frame members 18 and 20 should be made of a material which is relatively strong and yet is flexible to a sufficient degree to allow it to be coiled. Thus, each of the frame members 18,20 is capable of assuming two positions, an open or expanded position such as shown in FIG. 1, or a folded position in which the frame member is collapsed into a size which is much smaller than its open position (see FIG. 10). The material should have a memory that allows the frame members 18 and 20 to spring back to the expanded position when unfolded from the folded position. Each of the frame members 18 and 20 may be merely retained within the respective frame retaining sleeve 19 and 21 without being connected thereto. Alternatively, each frame retaining sleeve 19, 21 may be mechanically fastened, stitched, fused, or glued in its respective frame member 18, 20 to retain it in position.

As previously stated, webs of material 15 and 17 extend across each panel 14, 16, respectively, and are held taut by the respective frame members 18, 20 when each panel is in its open position. The term fabric is to be given its broadest meaning and should be made from strong, lightweight materials and may include meshed materials, woven fabrics, sheet fabrics or even films. The fabric should be water-resistant and durable to withstand the wear and tear associated with rugged outdoor use or rough treatment associated with birds and that wish to build nests and similar structures.

As illustrated best in FIGS. 1 and 3, the frame retaining sleeves 19 and 21 may be attached to the web of materials 15 and 17 along the side edges 14a-14d and 16a-16d of the panels 14 and 16, respectively. Specifically, the web of material 15 can be attached to the frame retaining sleeve 19 by the stitching 27 that extends along the side edges 14a-14d and the web of material 17 can be attached to the frame retaining sleeve 21 by the stitching that extends along the edges 16a-16d. The stitching 27 can also operate to enclose the frame retaining sleeves 19 and 21. Alternatively, the frame retaining sleeves 19 and 21 can be a part of or an extension of the webs of material 13, 15, 17, and/or 23, where the side edge of the webs of material 13, 15, 17, and/or 23 is wrapped around the respective frame member 18 or 20 to enclose the appropriate frame member 18 or 20, and then the stitching 27 applied to enclose the sleeve 19 or 21.

Thus, the flexible and coilable nature of the frame member 18 allows the front panel 16 to be flexed so that its end edges 16a and 16b can be positioned adjacent the end edges 14a and 14b of the back panel 14. In this regard, the flexing of the front panel 16 obviates the need to otherwise provide a plurality (e.g., at least three) of separate panels to enclose the interior space 31. The base panel 12 and/or the top panel 22 function to hold the front panel 16 in its flexed configuration.

The birdhouse 10 further includes an entrance or opening 26 that allows a bird access to the interior 31 of the birdhouse 10. In a preferred embodiment, an edging material 29 is secured about the opening 26 by stitching or the like. The entrance 26 may be of any size, but is preferably the size of an opening of a typical birdhouse, approximately 1¼″. It should also be understood that the entrance 26 may be arranged in a wide variety of areas and shapes. For instance, the entrance could be a narrow elongated slot near the bottom panel 12, which would allow the birdhouse 10 to be used as a bird feeder instead of a birdhouse.

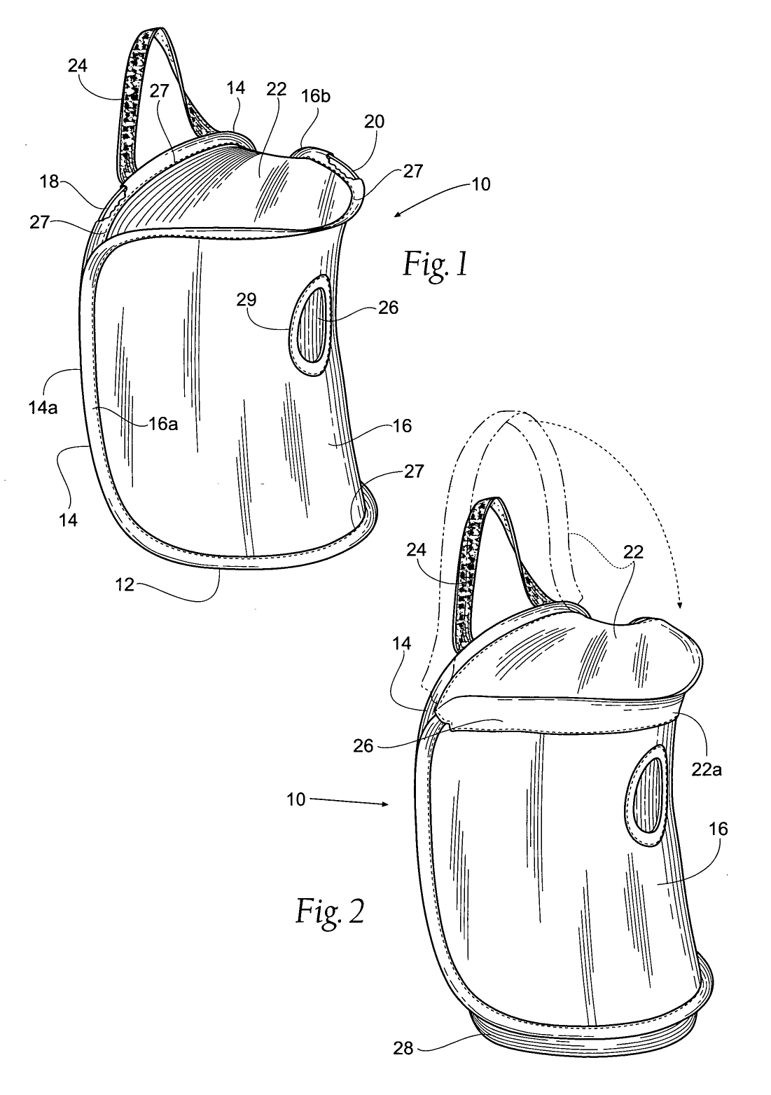

FIG. 2 shows a perspective view of an alternate configuration of birdhouse 10. The top panel 22 is completely or partially removable, thereby allowing access to the interior of the birdhouse 10. Attachment means 26 allow the top panel 22 to be removably secured to the birdhouse 10. The attachment means 26 can comprise any suitable devices, such as hoop and loop material, snaps, hooks, or any other device that will sufficiently adhere panel 22 to the birdhouse 10. As shown, the top panel 22 could be hingedly attached to the rear panel 14 and secured with a flap 22a over the front panel 16 (hinged movement represented in phantom). The embodiment shown in FIG. 2 also includes a counter weight 28 located on the bottom panel 12 for balancing the birdhouse 10. The counterweight 28 could be located internally or externally of the birdhouse 10, preferably along the bottom panel 12. The counter weight 28 will minimize movement of the birdhouse 10 in windy conditions or the like. Additionally the attachment means 24 could be arranged and connected to both the bottom panel 12 and top panel 22 to prevent unnecessary movement of the birdhouse 10, with or without the counterweight 28. All of these configurations fall within the scope of the present invention.

FIG. 4 shows a perspective partially cut-away view of the birdhouse 10. The birdhouse 10 is supported from a tree 40 with the attachment means 24 latched over a nail, branch, or similar extending structure 42. Within the interior 31 of the birdhouse 10 is a bird nest 44. The webs of material 13, 15, 17 and 23 that cover the birdhouse 10 are preferably opaque materials, which will provide the privacy birds desire when building the nest 44.

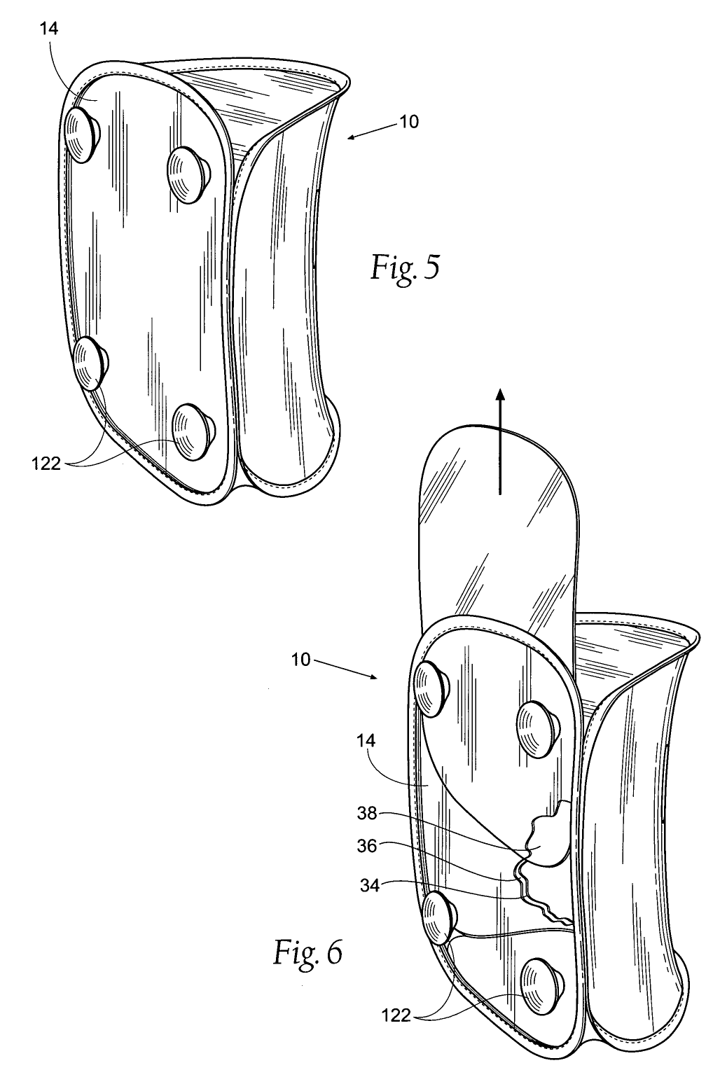

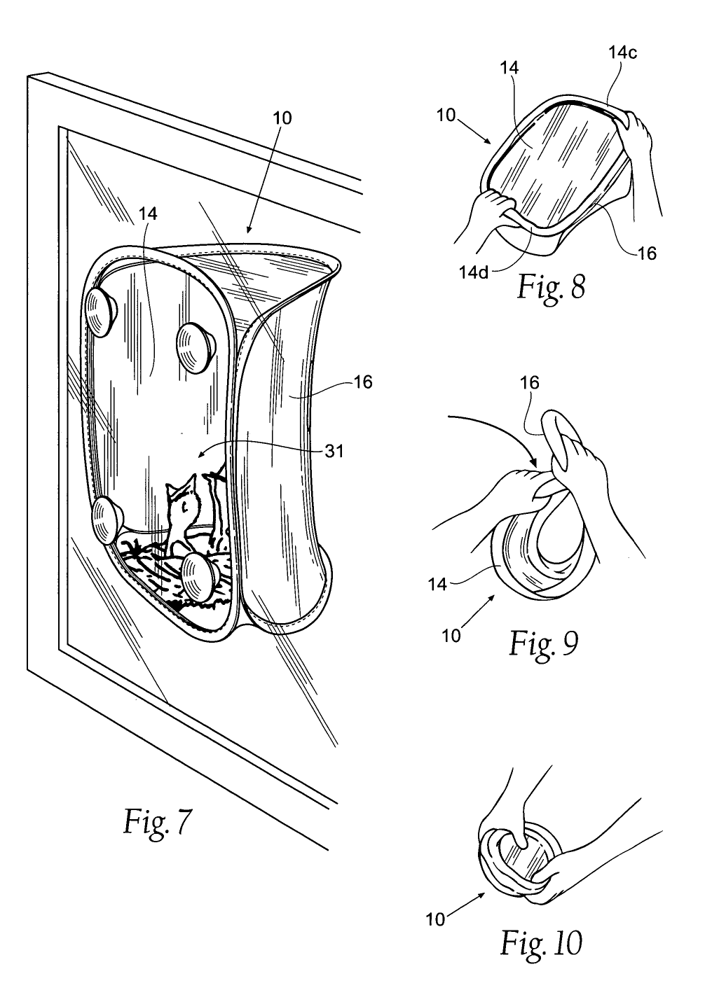

FIG. 5 shows a rear perspective view of the birdhouse 10. The birdhouse 10 is the same as previously described, except the attachment means 24 now comprise suction cups 122. The suction cups 122 allow the birdhouse 10 to be adhered to a flat surface, such as a window. As shown in FIG. 5, back panel 14 is again formed from an opaque material or web 15 and it is not possible to see through the back panel 14.

However, as shown in FIG. 6, in an alternate configuration, the birdhouse 10 may further include a transparent inner panel 34, which, together with a transparent back panel 14, forms a pocket 36. The pocket 36 holds a removable wall 38. The wall 38, which is preferably made of a solid, opaque material, prevents visual access into the inside of the birdhouse 10. However, when the wall 38 is removed, a person may look inside the birdhouse 10.

As previously noted, birds generally will not build a nest where they do not have privacy and where the nest is viewable, especially by humans. However, birds will also generally not move away from a nest or relocate the nest once the nest is built. Thus, the present invention provides a structure for a bird to build a nest in the privacy of the interior 31 of the birdhouse 10, while allowing the removal of wall 38 when the nest is completed thereby allowing people to watch the nest up close. The clear or translucent panels 14 and 36 allow viewing of the nest with the chance of the birds leaving the nest minimized. Because the bird nest is separated from human contact by a window, which will prevent most sounds from disturbing the birds, the present invention further provides a unique birdhouse 10 and viewing experience. The birdhouse 10 could be built without the inner panel 36, but placement of the inner panel 36 as described minimizes any disturbance of the bird nest when removing the wall 38, and further holds the inner panel 36 in position.

FIGS. 8-10 show steps for the birdhouse 10 to be folded and collapsed. FIG. 8 shows the birdhouse 10 being grasped at opposite edges of the back panel 14, preferably at the edges 14c and 14d of the back panel 14 that abut or are connected to the bottom panel 12 and the top panel 22. The birdhouse 10 is then twisted inwardly, as shown in FIG. 9. This flexes the back panel 14, which is pushed towards the front panel 16. As the birdhouse 10 is further twisted inwardly, the back panel 14 will collapse against the front panel 16. Eventually, as shown in FIG. 10, the back panel 14 and the front panel 16 will be twisted into a series of concentric circles. The collapsed structure of the birdhouse 10 is a fraction of the size of the expanded birdhouse 10, which makes it easy for storage or manufacture and distribution of the birdhouse 10. Additionally, the birdhouse 10 could be stored in a small bag or container (not shown). Expanding the birdhouse 10 is easy as well. Once an external resistance is removed from the birdhouse 10, such as the force of a storage bag pressing upon the birdhouse 10, the frame members 18 and 20 will preferably expand quickly to the shape of the panels 14 and 16.

The frame members 18 and 20 may be attached to the panels 14 and 16 in several ways. For example, the frame members 18 and 20 may be sewn to the panels 14 and 16, or pockets may be located on the panels 14 and 16 to allow removal of the frames 18 and 20, if necessary. Likewise, the area of the frames 18 and 20 that defines the edges 14a, 16a and 14b, 16b, may be connected to the panels 14 and 16 within the same pocket or area. That is, the edge 14a and the edge 16a may form a single area where the corresponding section of the both frames 18 and 20 are housed, and the edge 14b and 16b may form another single area for housing a corresponding section of the frames 18 and 20. The sleeves 19 and 21 may overlap and, in fact, be the same structure at the edges 14a, 16a and 14b, 16b, with or without having a dividing structure located within these areas. Provided that a birdhouse will collapse and expand as discussed, any arrangement and connection of the frames 18 and 20 to the panels 14 and 16 will fall within the scope of the present invention.

The panels of the birdhouse are preferably made of a PVC nylon material or tarp material, or other flexible material that will be durable enough to prevent birds from making holes in the birdhouse 10, or prevent squirrels and other animals from chewing through the material.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

1. A collapsible structure comprising:
a bottom panel;
a back panel having a foldable frame member, said frame member having a foldable and unfoldable orientation, said back panel having first and second edges;
a front panel having a foldable frame member, said frame member having a foldable and unfoldable orientation, said front panel having first and second edges, said front panel having an opening;
said front panel and said back panel connected to one another at said respective first and second edges;
a top panel; and
means for attaching said collapsible structure to a support.

2. The collapsible structure according to claim 1 wherein said attaching means comprises at least one loop of material.

3. The collapsible structure according to claim 2 further comprising a weight for stabilizing said structure, said weight being attached to at least one of said panels.

4. The collapsible structure according to claim 1 wherein said attaching means comprises suction cups.

5. The collapsible structure according to claim 1 wherein said structure further comprises:
an inner panel spaced apart from said back panel;
a pocket, said pocket formed by said back panel and said inner panel; and
a removable wall located within said pocket.

6. The collapsible structure according to claim 5 wherein said back panel and said inner panel are made of a see-through material.

7. The collapsible structure according to claim 6 wherein said removable wall is made of an opaque material.

8. The collapsible structure according to claim 1 wherein the top panel is removably secured to the structure.

9. The collapsible structure according to claim 1 wherein the bottom panel is removably secured to the structure.

10. The collapsible structure according to claim 1 wherein said top panel is hingedly connected to said structure.

11. A collapsible structure comprising:
a bottom panel;
a back panel having a foldable frame member, said frame member having a foldable and unfoldable orientation, said back panel having first and second edges, said back panel comprising a see-through material;
a front panel having a foldable frame member, said frame member having a foldable and unfoldable orientation, said front panel having first and second edges, said front panel having an opening;
said front panel and said back panel connected to one another at said respective first and second edges;
a removable wall located adjacent said back panel;
a top panel; and
means for attaching said collapsible structure to a support.

12. The collapsible structure according to claim 11 wherein said attaching means comprises suction cups, said suction cups located on said back panel.

13. The collapsible structure according to claim 12 wherein at least one of said top and said bottom panels is removably secured to said collapsible structure.

14. The collapsible structure according to claim 12 wherein at least one of said top and said bottom panels is hingedly attached to said structure.

15. The collapsible structure according to claim 11 wherein said removable wall is made of an opaque material.

16. A collapsible birdhouse comprising:
a bottom panel;
a back panel having a foldable frame member, said frame member having a foldable and unfoldable orientation, said back panel having first and second edges, said back panel comprising a see-through material;
a front panel having a foldable frame member, said frame member having a foldable and unfoldable orientation, said front panel having first and second edges, said front panel having an opening;
said front panel and said back panel connected to one another at said respective first and second edges;
a removable opaque wall located adjacent said back panel;
a top panel; and
means for attaching said collapsible structure to a support.

17. The birdhouse according to claim 16 further comprising:
a see-through inner panel, said inner panel and said back panel forming a pocket, said removable wall being located within said pocket.

18. The birdhouse according to claim 17 wherein said attaching means comprises suction cups.

19. The birdhouse according to claim 18 wherein at least one of said top and said bottom panel is removably secured to said birdhouse.

20. The birdhouse according to claim 17 wherein at least one of said top and said bottom panels is hingedly attached to said birdhouse.
